(19) United States
(12) Patent Application Publication
(10) Pub. No.: US 2014/0353400 A1
(43) Pub. Date: Dec. 4, 2014

(54) APPARATUS FOR THERMAL STABILIZATION OF PAINTING ATOMIZATION DEVICES ACCORDING TO PRESET VALUES

(71) Applicant: EUROSIDER S.A.S. di Milli Ottavio & C., Grosseto (IT)

(72) Inventor: Ottavio MILLI, Grosseto (IT)

(73) Assignee: EUROSIDER S.A.S. di Milli Ottavio & C., Grosseto (IT)

(21) Appl. No.: 14/152,485

(22) Filed: Jan. 10, 2014

(30) Foreign Application Priority Data
Jun. 3, 2013 (IT) FI2013A000134

(51) Int. Cl. B05B 7/16

(52) U.S. Cl. CPC B05B 7/1606
USPC 239/75

(57) ABSTRACT

An apparatus for thermal stabilization according to predetermined parameters that is designed for and can be coupled to atomization devices for air spray-painting systems, of the type including a body (1) made of a thermally conductive material provided with at least one outlet (2) for a flow of atomized paint, and provided inside with an atomization circuit (4) including a first duct (5) for delivery of a pressurized atomization fluid and a second duct (6) for supplying an amount of paint to be atomized, the apparatus including: a conductive body (9) in thermal contact with the body of the atomization device; adjustable elements for heat conditioning of the conductive body; and sensors (11) for detecting the temperature of the heat-exchanger body in order to enable or disable the heat-conditioning elements in response to a difference between the detected temperature (Tr) and a desired temperature (Tv) of the conductive body.

### SECTOR OF THE INVENTION

The invention relates to an apparatus for thermal stabilization, that is designed for and can be coupled to atomization devices for air spray-painting systems, the thermal stabilization being obtained by heating or cooling said atomization devices used in industrial painting, for example paint-spray guns or rotary-bell atomizers.

In particular, the apparatus finds application in painting systems for production of dried and filtered compressed air, or modified air enriched in nitrogen, or binary or ternary mixtures constituted by molecular elements that make up the atmosphere, for example nitrogen, argon, and oxygen, designed for spray painting, with air spray systems, low pressure systems, or rotary-bell systems, or other systems operating at high pressure, for technical control of the paint-carrier fluid as regards the preferred temperatures for keeping the viscosity constant.

### PRIOR ART

It is known that in the steps of automatic painting, in particular using air guns, low pressure guns, or rotary-bell atomizers, to obtain atomization of the paint there is frequently used as carrier fluid compressed air or modified air rich in nitrogen at room temperature or preheated. Usually, the pressures used for atomization and for the spray fan range between 10 and 0.3 bar. It is thus evident that, in the atomization step, the paint carrier tends to cool as a result of expansion; hence the guns undergo cooling, and consequently also the atomized fan cools and interferes with the viscosity, thus creating problems on the spreading, penetration, and evenness of the thicknesses of the film of paint applied on the products, jeopardizing the quality and finish.

As the ambient temperature varies, this effect is even more evident because, for example, in hot periods the expansion of air is greater and causes a colder fan with consequent difficulty of spreading of the film of paint. In fact, the paint is affected by the variables that may create problems of grip of the paint on the substrate to the painted and of evenness of the thicknesses themselves. Moreover, the relative humidity that is naturally present in air creates a further interference as regards atomization, producing a non-perfect application, for example causing the effect of microbubbles determined by microparticles of humidity that remain trapped underneath the film of paint thus subsequently leading to cracking of the film of paint as a result of the changes of ambient temperature.

It is to be emphasized that, for a perfect application of a layer of paint, whether solvent-based, water-based, or of some other type, the ideal temperature is preferably between 15° C. and 25° C. with possible variations according to the ambient operating temperatures.

In the current state of the art systems are known for heating the carrier fluid, described for example in the patents filed in the name of the present applicant under Nos. EP1819445 and EP1778406.

However, known systems are not satisfactory for keeping the viscosity of the paint constant, in particular in robotized automatic painting systems.

### OBJECT OF THE INVENTION

A first object of the present invention is thus to provide an apparatus that will be free from the aforesaid drawbacks of the known systems described above and that will be able to maintain the temperature of the gun or of the paint-atomization device constant at a pre-set optimal temperature, in order to keep the viscosity of the paint constant and eliminate the lack of uniformity of the thicknesses and the consequent production rejects.

A second object of the present invention is to provide an apparatus for heat conditioning of the paint-atomization device (gun or rotary-bell atomizer), in particular of the type mounted on automatic painting robots that usually work within paint booths in so-called “classified” environments (i.e., with a high risk of explosion where the presence of any electrical part is not allowed unless purposely certified according to the ATEX directives or in any case international directives for environments with high risk of explosion, such as NFPA, areas classified as “Hazardous (Classified) Locations, class I, II, III, divisions 1,2”).

A further object of the present invention is to propose an apparatus as described above, suitable for installation both on paint-atomization devices (spray guns or rotary-bell atomizers) just being produced and on paint-atomization devices already used on painting lines in industrial and professional plants.

### SUMMARY OF THE INVENTION

The above and further purposes have been achieved with an apparatus according to one or more of the annexed claims.

A first advantage of the invention lies in the fact that the paint, passing through the atomization circuit in the body of the atomization device exchanges heat therewith, and hence with the particles of paint during atomization, in such a way as to maintain the viscosity of the paint constant in order to achieve a perfect spreading of the film of paint applied on the substrate and a faster evaporation and drying, respecting the temperatures indicated by paint manufacturers in order not to change the physico-chemical characteristics of the product.

Further advantages are the following:
the system can be applied on any type of conventional automatic gun and on rotary-bell atomizers, and is easy to apply and remove; the heat exchanger can, in fact, be applied to the guns already operating and inserted according to the best position on any side of the guns themselves irrespective of their shape;
the system can be used inside the paint booth in so far as it is supplied by a hot thermovector liquid, preferably an ecological liquid (or fluid, for example, air or mixtures of air modified in nitrogen), without electrical connections that are forbidden by current ATEX safety standards or in any case appropriate international reference standards;
the system enables the temperature of the guns to be kept constant in the moments of stoppage thereof according to the programmed cycles, for example in robotized systems; it is known, in fact, that when a robot, whether anthropomorphic or fixed, terminates its working cycle, the gun goes into standby mode for a new working cycle that may be more or less long; in this period the gun tends to cool or heat, thus losing the preset reference value of temperature and viscosity ideal for a perfect application of the paint; this is extremely important in so far as the quality of the painting process and the finish and uniformity of the thicknesses of the film are determined by the constancy in temperature since, as the latter varies, the viscosity of the paint changes, which affects the uniformity of the thicknesses, spreading of the paint, and quality of the finish;
the system makes enables use of smaller spray nozzles, for example, 0.9-mm ones instead of 1.4-mm ones, in so far as the temperature of the gun causes a better fluidification of the paint during atomization, and hence it is possible reduce the solvents, with considerable savings in the consumption of paint, for example up to 50%, thus reducing noxious emissions into the atmosphere (VOC) in so far as the gun, by operating at constant temperature, enables reduction of the carrier pressure (whether air or nitrogen); for example, a spraying pressure of 5 bar may be reduced to 1.5 bar, thus obtaining all the benefits mentioned above.

A further advantage is achieved in so far as, since it is possible to use smaller nozzles and to improve the transfer efficiency by approaching the guns to the substrates to be painted, the waste of product is reduced considerably with marked reduction of overspray, with an increase of the transfer efficiency of up to 90%.

The system can be adopted both on guns already operating installed on board automatic systems or robots and during production of new guns, in which case there may be provided an enveloping chamber for heat exchange in order to obtain heating of the chamber itself, which is provided in the body of the gun.

In the cases of operation in very hot environments, when the temperatures of application exceed the values indicated in the data sheets for the paints, for example +18° C. to +25° C., the apparatus according to the invention enables reduction of the temperature, causing flow of a cold thermovector liquid or air or mixtures supplied by a cooler, for example a plate chiller, that will make it possible to work with the parameters suitable for keeping the viscosity of the paint constant. In fact, atomization temperatures higher than 25° C. create problems of running, pitting, in addition to the orange-peel effect.

### LIST OF THE DRAWINGS

The above and further advantages will be better understood by any person skilled in the branch from the ensuing description and from the annexed drawings, which are provided by way of non-limiting example and in which:

FIG. 1 shows an apparatus according to the invention applied to an atomization device;

FIG. 1a is an exploded view of the apparatus and of the device of FIG. 1;

FIG. 2 is an exploded view of the apparatus of FIG. 1;

FIGS. 3, 3a-3c are side and cross-sectional views of the apparatus of FIG. 1;

FIG. 4 shows an apparatus according to the invention, integrated in the body of an atomization device;

FIG. 5 shows tables regarding the technical characteristics of a thermovector liquid;

FIG. 6 shows a painting plant with an apparatus according to the invention;

FIG. 6a shows a further preferred embodiment of a painting plant with an apparatus according to the invention;

FIG. 6b shows a multiple apparatus for heating three dispensers;

FIG. 7 shows a detail of a heat-conditioning unit according to the invention;

FIG. 8 is a schematic illustration of a stretch of the ducts for conveying the carrier fluid and the thermovector fluid that are enclosed in a thermally insulating sheath;

FIG. 9 shows a further embodiment of the invention showing a plurality of apparatus connected by a hydraulic collector;

FIG. 10 shows a further embodiment of an apparatus according to the invention, integrated in the body of an atomization device;

FIG. 11 shows the apparatus of FIG. 10 in a front view;

FIG. 11a shows the apparatus of FIG. 11 according to section A-A;

FIGS. 12-14a,b respectively show an exploded view, a rear view and a section view A-A and B-B of a further embodiment of a heating according to the invention, made by welded metal sheets or plates;

FIGS. 15-16 respectively show the heating body of FIGS. 12-14 according to a perspective view and a section view A-A thereof.

### DETAILED DESCRIPTION

With reference to the drawings, described hereinafter is an apparatus for heat conditioning of an atomization device for air-painting systems comprising a body 1 made of a thermally conductive material and provided with at least one outlet 2 for a flow of atomized paint designed to form a spray fan V on a substrate S to be painted.

Preferably, the body 1 is a one piece body or made of welded plates, by example in stainless steel or aluminium plates.

The atomization device, which is of a type in itself known, is provided inside with an atomization circuit 4 comprising a duct 5 for delivery of a pressurized atomization fluid and a second duct 6 for supply of an amount of paint to be atomized.

By way of example, the atomization device may use as atomization fluid dried and filtered compressed air or modified air enriched in nitrogen, or binary or ternary mixtures constituted by molecular elements that make up the atmosphere, for example nitrogen, argon, and oxygen, in combination with air spray systems, airmix systems, or rotary-bell systems or other high-pressure systems, which envisage control of the carrier for atomization of the paint according to the preferred temperatures for keeping the viscosity constant.

The heat-conditioning apparatus according to the invention comprises a heat-exchanger body 9 that in use is in thermal contact with the body 1 of the atomization device, and adjustable means for heat conditioning of the heat-exchanger body 9 that are enabled or disabled by purposely provided sensors 11 for detecting the temperature of the heat-exchanger body in response to a difference between the temperature Tr detected and a desired temperature Tv. Control in temperature of the body 9 is consequently obtained via the temperature sensor 11, which sends to the heat-conditioning means an appropriate signal for the system for self-regulation of the temperature. Preferably, the heat-exchanger body 9 is made of aluminium or shaped sheet metal, or else some other material in such a way that, once positioned in contact with the atomization device, for example a gun body usually having a square shape, it transmits heat or cold thereto bringing it to the desired temperature Tv, ranging, for example, between +100° C. and −10° C.

It is to be understood that these values are purely indicative and depend upon the ambient conditions of painting and upon the characteristics of the painting products used, and may be adapted and optimized in order to obtain an atomization at the ideal temperatures for keeping the viscosity of the paint used constant.

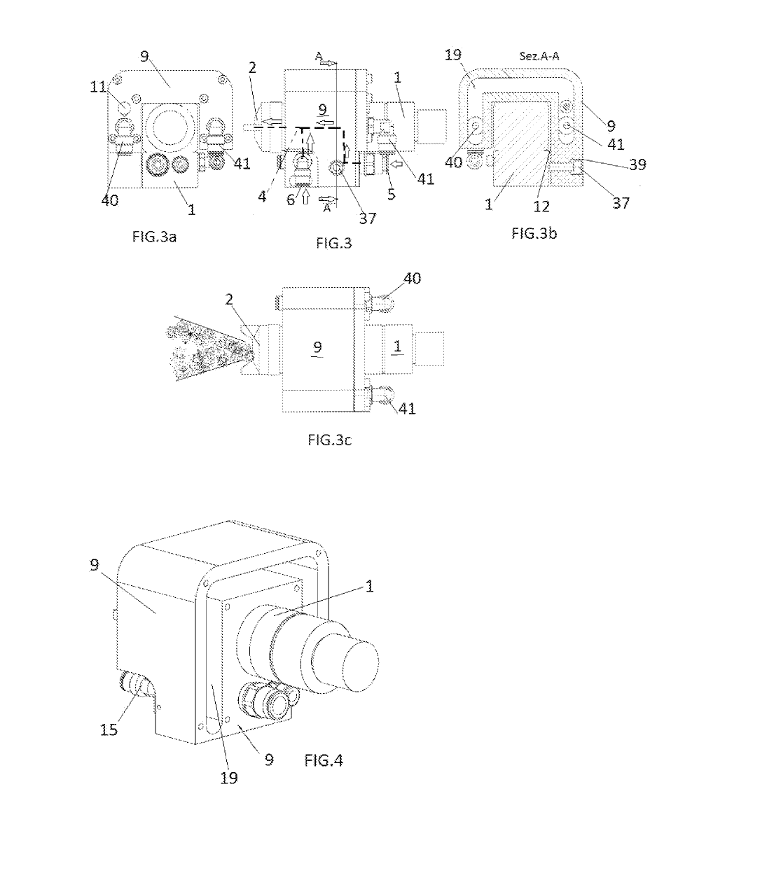

With reference to FIGS. 1-3, a first preferred embodiment of the apparatus is described, where the heat-exchanger conductive body 9 can be separated from the body 1 of the atomization device and is in contact therewith via a heat-exchange surface 12.

For example, when the atomization device is a gun having a quadrangular shape, the conductive body 9 is shaped like a U turned upside down, is preferably thermally insulated on the outside, and acts as heat exchanger on the body 1 of the gun.

In greater detail, the heat-exchanger body 9 is made up of a main portion 38 joined via a shaped gasket 34 and screws 36 to a lid 35. The body 9 may moreover be fixed to the body 1 of the gun via a pressure screw 37 passing through a corresponding hole 39 of the heat-exchanger body 9.

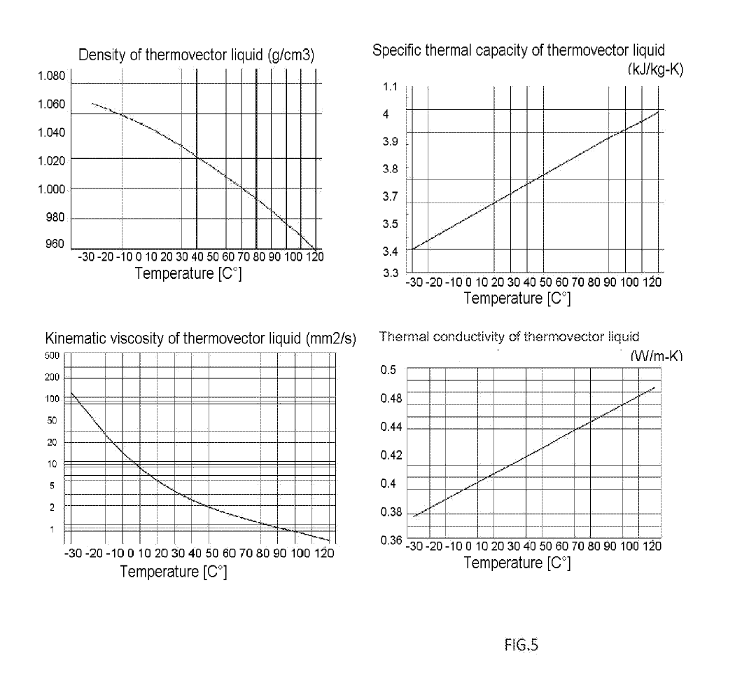

FIG. 4 shows a second embodiment in which the heat-exchanger body 9 is made integrally with the body 1 of the atomization device.

According to the invention, the heat-conditioning means comprise a conduit 19 for passage of a thermovector fluid that circulates between a point of inlet 40 and a point of outlet 41 in heat exchange with the heat-exchanger body 9.

With this solution, the heat-exchanger body 9 is heated or cooled via the thermovector fluid (preferably a liquid) previously heated or cooled, and sensor 11 may be in direct thermal contact with the thermo vector fluid.

For transfer of the heat to the apparatus a thermovector fluid is preferably used having a high heating load with a base of propylene glycol, water, and inhibitors, having, by way of example, the characteristics listed below.

| | | |
|---|---|---|
| Appearance | clear liquid, fluorescent red | |
| Density at 20° C. | 1.032-1.035 g/cm³ | ASTM D 1122 |
| Refractive index (20° C.) | 1.380-1.384 | DIN 51757 |
| pH | 9.0-10.5 | ASTM D 1287 |
| Residual alkalinity | min. 20 ml 0.1n HCl | ASTM D 1121 |
| Viscosity (20° C.) | 4.5-5.5 mm²/s | DIN 51562 |
| Boiling point | 102-105° C. | ASTM D 1120 |
| Flammability point | none | DIN 51376 |
| Specific humidity | 55-58% | DIN 51777 |
| Protection from cold | up to −28° C. | ASTM D 1177 |

Appearing in FIG. 5 are the reference tables for the thermovector fluid, namely:

density of the thermovector liquid (g/cm³),
kinematic viscosity of the thermovector liquid (mm²/s),
specific thermal capacity of the thermovector liquid (kJ/(kg·K)),
thermal conductivity of the thermovector liquid (W/(m·K))

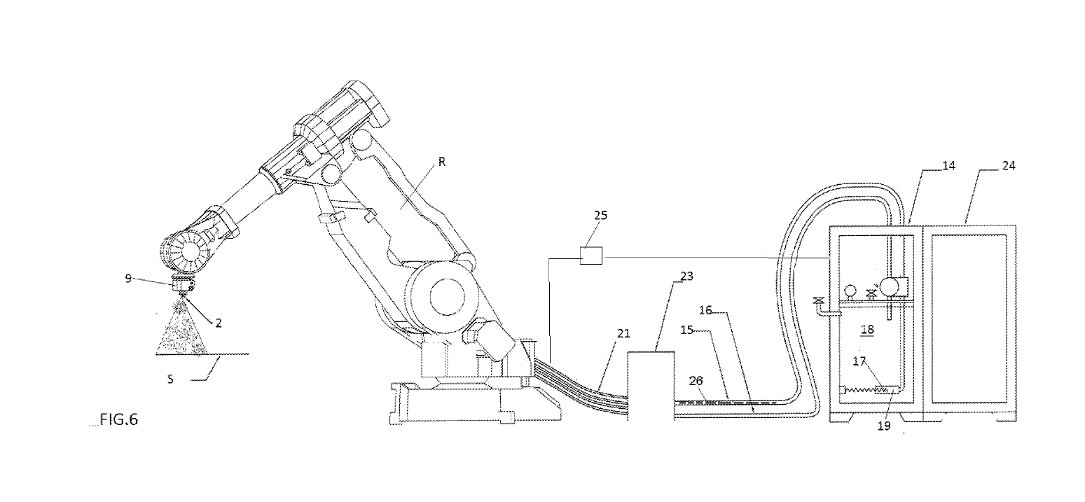

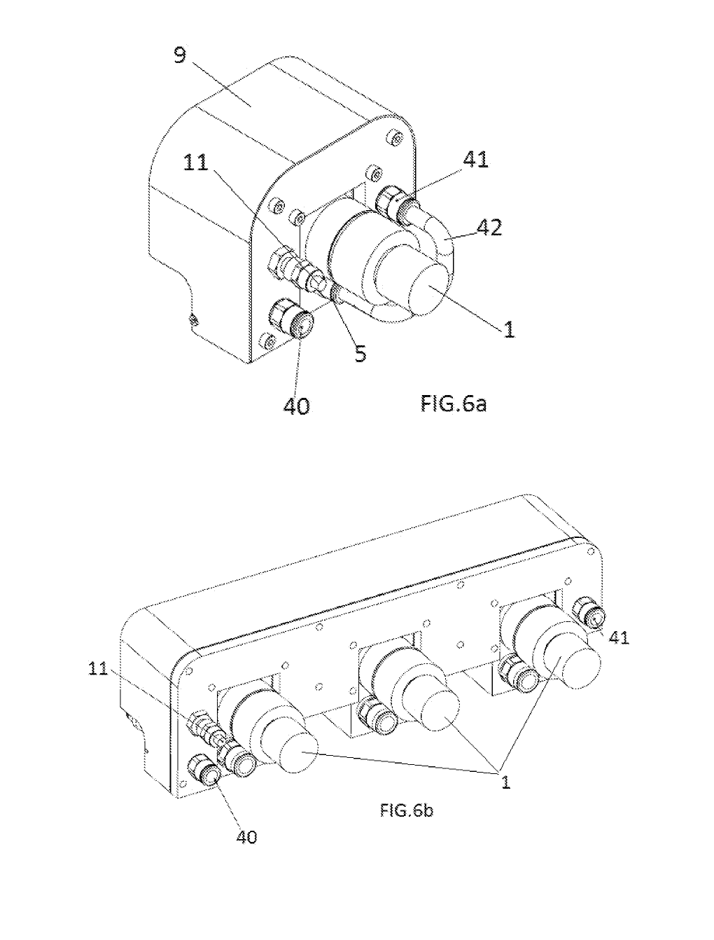

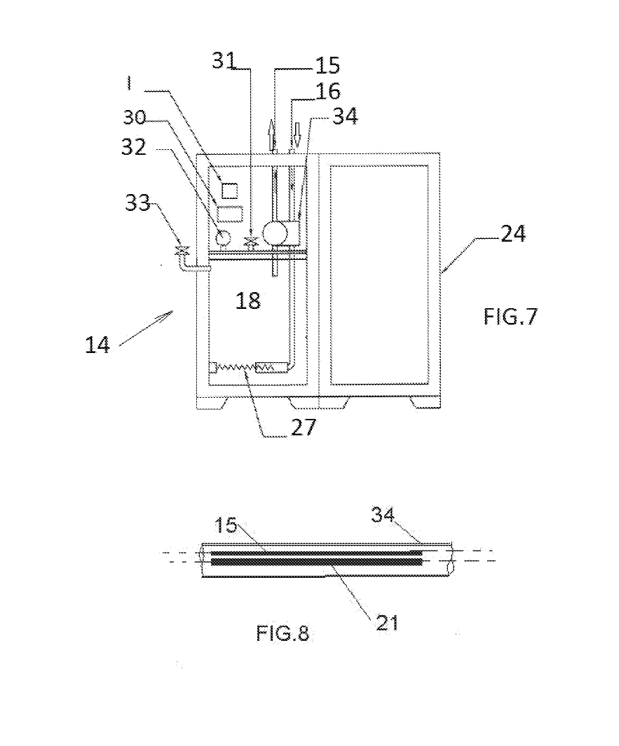

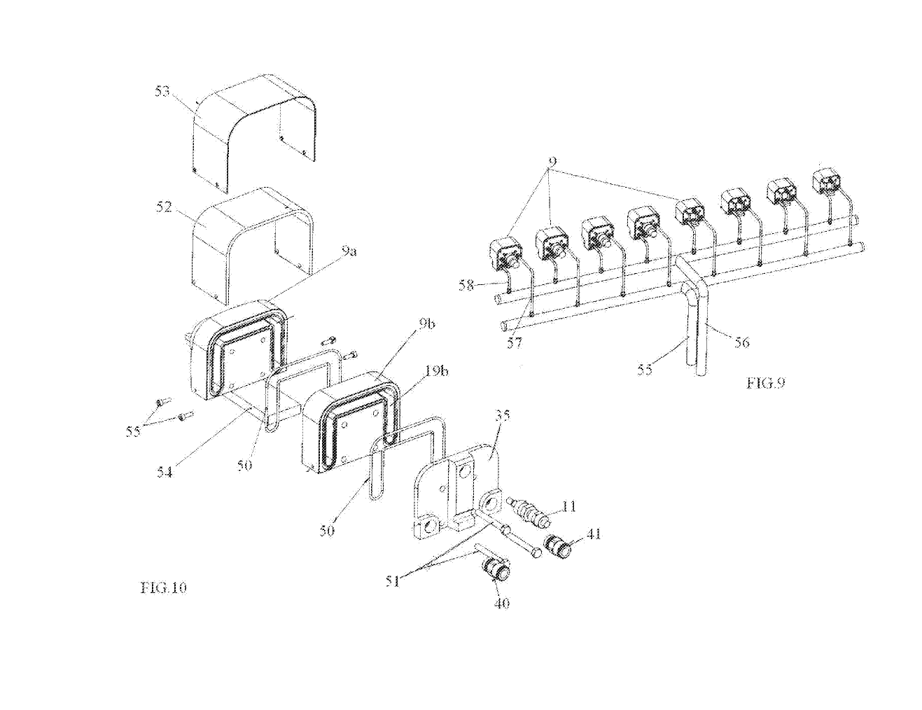

With reference to FIGS. 6 and 7, the conduit 19 is connected to a heat-conditioning unit 14 for the thermovector fluid set at a distance from the conductive body 9 and connected to the conduit 19 via ducts for delivery 15 and return 16 of the fluid, moved by a recirculation pump 34.

Advantageously, this solution makes it possible to have only passive heating elements in the proximity of the atomization device and to install the heat-conditioning elements, which are normally supplied at the grid voltage, outside the painting area in non-classified areas with risk of explosion or fire.

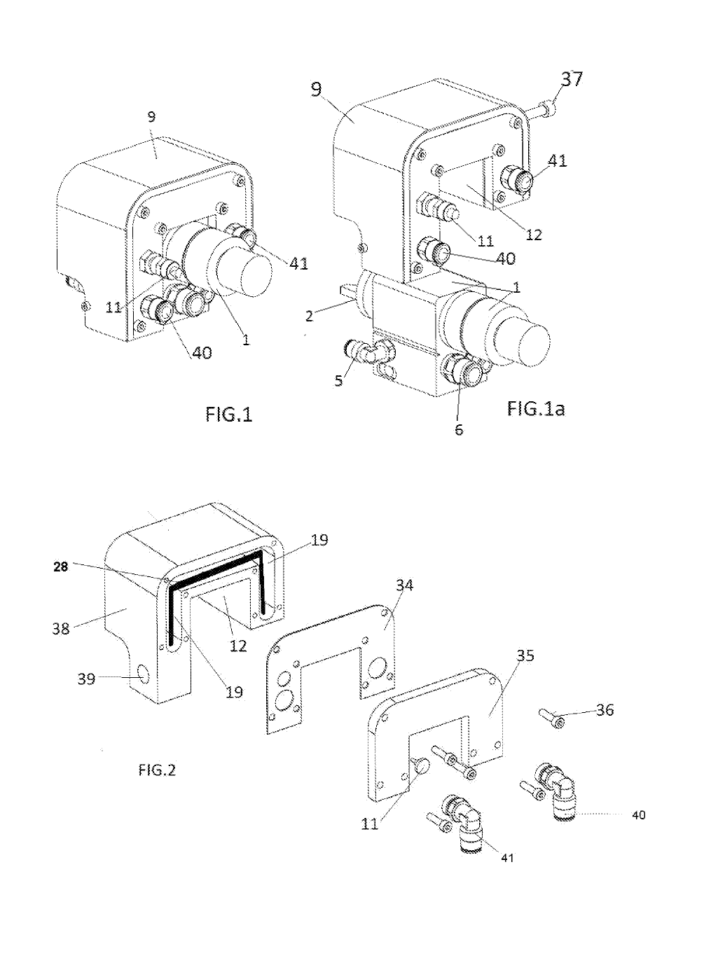

When the apparatus is used in an environment without any risk of explosion or fire, the conduit 19, instead of being used for passage of a thermovector fluid, may be used for housing an electrical resistance 28, represented schematically in FIG. 2, supplied in a conventional way and possibly inserted in an explosion-proof container.

The heat-conditioning means of the unit 14 may be of different types and comprise, for example, an insulated electrical resistance 26 (represented schematically in FIG. 6), preferably a low-voltage one, inserted in one stretch at least of the delivery duct 15, which, in contact with the thermovector fluid, keeps the temperature thereof constant throughout said stretch.

With this solution, even if the ducts 15, 16 were to be very long, for example beyond 10 m, the heat is prevented from dissipating along the path.

In addition or as an alternative, heating of the thermovector fluid may be obtained by means of an electrical resistance 27 immersed in a reservoir 18 of thermovector fluid and operatively connected to a thermoregulator 30.

In the case where it is desired to cool the thermovector fluid, the heat-conditioning means may comprise an adjustable cooling device 24, for example a plate chiller, operatively connected to a thermoregulator 30.

Once again with reference to FIG. 6, the apparatus is advantageously used in combination with an automatic air-painting plant, comprising an automatic arm R carrying an atomization device 1 for sending a spray fan V on a substrate S. Preferably, in this embodiment, the atomization device is connected to ducts 21 for conveying a flow of a carrier atomization fluid, which is in turn thermally conditioned by regulatable heat-conditioning means 23, and the ducts 21 are thermally coupled to the duct 15 for delivery of thermovector fluid in order to bring into equilibrium the temperature of the body of the atomization device 1 and of the paint-atomization carrier fluid.

Advantageously, with this solution, there is obtained a perfect atomization at constant viscosity as a result of transmission of heat, or of cold, via thermal coupling of the thermovector tubes with that for the paint carrier, with the possible thermal insulation thereof. This is particularly important in the steps of start and stop of the production cycle, in particular in cycles managed by robots. The problem of maintaining and controlling constancy of the temperature in any moment of the operating cycle in order to guarantee that the viscosity of the paint is kept constant is thus solved.

Advantageously, the apparatus further comprises a sensor 25 for detecting the pressure of the atomization carrier fluid in the ducts 21 in such a way as to enable heat conditioning of the thermovector fluid only in the presence of a predetermined operating thrust pressure and disable it in the absence of said operating pressure.

With this solution it is possible to reduce rapidly the temperature of the recycling liquid in the apparatus in order to prevent triggering of cross-linking of the paint within the gun, thus preventing any waste of time and production stoppages for cleaning and refurbishing the guns themselves.

FIG. 6a illustrates a preferred embodiment of the invention, where the paint-carrier fluid (for example nitrogen) is a heated fluid and is sent first into the conduit 19 of the apparatus via the inlet 40, whilst the outlet of the conduit 41 is connected by means of a duct 42 to the inlet 5 for the carrier fluid into the atomization device, thus determining perfect equilibrium of the temperatures of the carrier atomization fluid and of the gun.

In order to obtain thermal equilibrium between the thermovector fluid and the carrier or atomization fluid, it may moreover be envisaged to couple thermally the ducts 21 for conveying the atomization fluid to the ducts 15, 16 for the thermovector fluid.

For example, the thermal coupling may be obtained by setting the ducts 21 and 15/16 alongside and enclosing them together in a thermally insulating sheath 34 (represented schematically in FIG. 8) thus achieving equilibrium of the temperatures of the atomization carrier fluid and of the thermovector fluid.

FIG. 6b illustrates the case of a plant that envisages a number of atomization devices, for example three, set in series for carrying out different steps of painting of the substrate, such as application of a basecoat, of a resin, and of a transparent paint.

In this case, a further advantage of the invention is that the apparatus may be installed alone or else more than one may be installed to implement steps of heating or cooling.

Finally, FIG. 7 illustrates by way of example a detail of a heat-conditioning unit 14 comprising a pump 34 for recirculation of the thermovector fluid, a safety valve 31 for the pressure of the thermovector fluid, a manometer 32 for control of the thermovector fluid, and a filler 33 for topping up the level of thermovector liquid, in addition to a switch I for turning-on and turning-off.

With reference to FIG. 9 it is disclosed a preferred embodiment of the invention intended to serve in parallel a number of atomization devices. In this embodiment, a plurality of apparatus is connected through inlet tubes 57 and outlet tubes 58 to ducts 55, 56 arranged to supply and respectively discharge the thermo vector fluid to and from the heating bodies 9. Advantageously with this arrangement the thermo vector fluid is supplied with an uniform temperature to the apparatus, so that it is possible to provide all the spraying devices with heating apparatus having all substantially the same temperature.

With reference to FIGS. 11 and 11a it is shown an embodiment of an apparatus of the invention in which the heating body is made integral with the body 1 of the atomization device.

In this embodiment, the heating body 9 is made of two detachable sections 9a, 9b connected through screws 51 and seals 50 and preferably superimposed on a conductive plate 54.

Sections 19a, 19b further comprise respective conduits 19a, 19b which in combination form the conduit 9 for passage of the thermo vector fluid.

An insulating sheath 52 and a cover 53 are also provided to insulate the heating body 9.

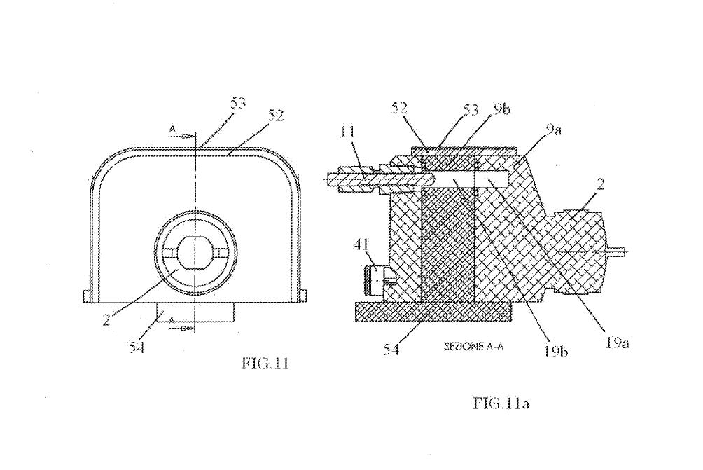

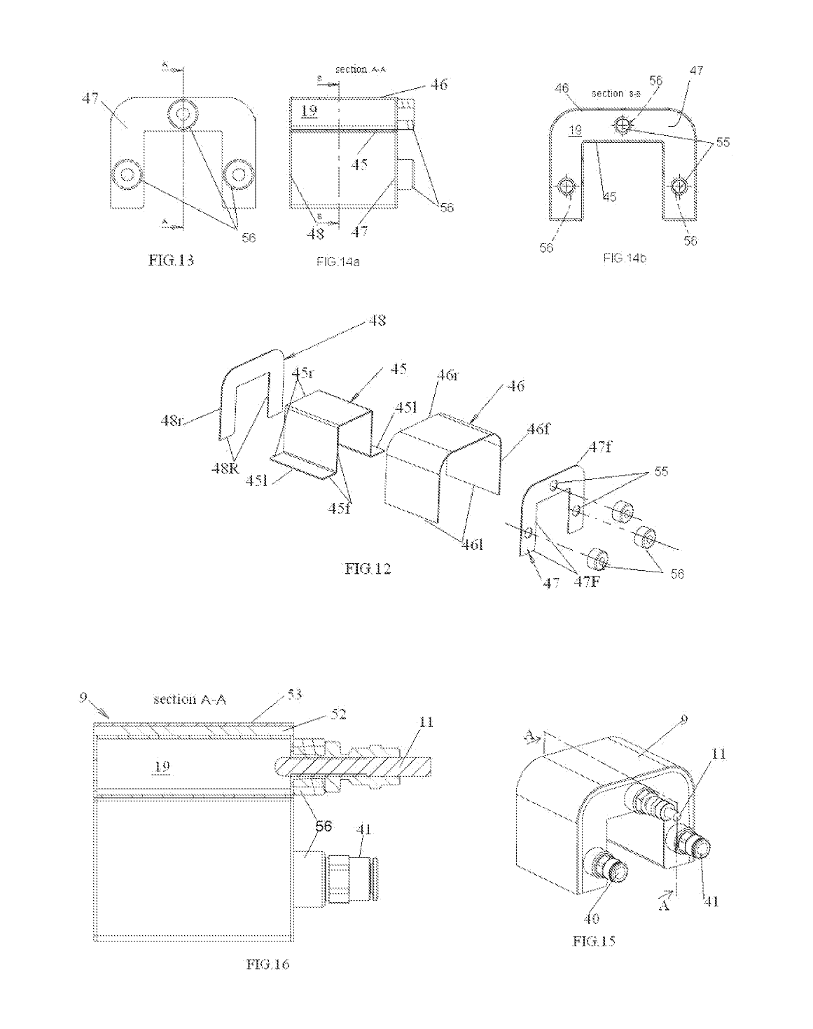

With reference to FIGS. 12-16 is shown an embodiment of an apparatus of the invention in which the heating body is a box shaped body made by welded sheets or plates.

In more details, the heating body 9 of FIG. 12—is preferably made by welding an inner Ω shaped plate 45 to an outer U shaped sheet 46 to form a channel 19 which is closed by front and rear plates 47, 48. Rear plate 48 is further provided with holes 55 having connections 56 intended to allow a fluid communication of channel 19 with inlet 40 and outlet 41 and the insertion of the thermal sensor 11.

In a preferred example:
plates 45, 46 are welded along respective lower edges 45l, 46l;
plates 45, 47 are welded along respective front edges 45f, 47F;
plates 45, 48 are welded along respective rear edges 45r, 48R;
plates 46, 47 are welded along respective front edges 46f, 47f;
plates 46, 48 are welded along respective rear edges 46r, 48r.

Preferably, plates 45-48 are metal plates made of stainless steel or aluminium. Advantageously, in this embodiment the heating body has a low weight and a reduced mechanical inertia, which is specifically helpful when the apparatus has to be applied to quickly moving painting head of robotised system or arms.

The present invention has been described according to preferred embodiments, but equivalent variants may be devised, without departing from the sphere of protection of the invention.

1. An apparatus for thermally stabilizing, according to pre-set thermal values, an atomization device for air-painting systems, of the type comprising a body (1) made of a thermally conductive material provided with at least one outlet (2) for a flow of atomized paint, and provided internally with an atomization circuit (4) comprising a first duct (5) for delivery of a pressurized atomization fluid and a second duct (6) for supplying an amount of paint to be atomized, said apparatus being characterized in that it comprises:
a thermally conductive body (9) in thermal contact with said body (1) of the atomization device;
adjustable means (24, 25, 26, 27, 28) for heat conditioning of the conductive body; and
sensors (11) for detecting the temperature of the thermally conductive body for enabling or disabling said heat-conditioning means in response to a difference between the temperature detected (Tr) and a desired temperature (Tv) of the conductive body (9).

2. The apparatus according to claim 1, wherein said conductive body (9) can be separated from said body (1) of the atomization device and is provided with a surface (12) for heat exchange therewith.

3. The apparatus according to claim 2, wherein said conductive body (9) is shaped like a U turned upside down thermally insulated on the outside that acts as heat exchanger on the body (1) of the atomization device.

4. The apparatus according to claim 1, wherein said conductive body (9) is made integrally with said body (1) of the device.

5. The apparatus according to claim 4, wherein heating body (9) is made of at least two detachable sections (9a, 9b) connected through connecting means (51) and seals (50), and further comprising respective conduits (19a, 19b) which in combination form a conduit (19) for passage of a thermovector fluid.

6. The apparatus according to claim 1, wherein an insulating sheath (52) and a cover (53) are also provided to insulate the heating body (9).

7. The apparatus according to claim 1, wherein a plurality of apparatus is connected in parallel through inlet tubes (57) and outlet tubes (58) to ducts (55, 56) arranged to supply and respectively discharge the thermovector fluid to and from the heating bodies (9).

8. The apparatus according to claim 1, wherein said heat-conditioning means comprise at least one electrical resistance (28) inserted in a conduit (19) of the conductive body (9).

9. The apparatus according to claim 1, wherein said heat-conditioning means comprise an inlet (40) and an outlet (41) at the ends of a conduit (19) for passage of a thermovector fluid in heat exchange with said conductive body (9).

10. The apparatus according to claim 9, comprising a unit (14) for heat conditioning of said thermovector fluid set at a distance from the conductive body (9) and connected to said conduit (19) via recirculation ducts for delivery (15) and return (16) of the fluid forced by a recirculation pump (34).

11. The apparatus according to claim 10, wherein said heat-conditioning means (24, 25, 26, 27, 28) comprise an insulated resistance (26), preferably a low-voltage one, inserted in a stretch of at least said delivery duct (15), which, in contact with the thermovector fluid, keeps the temperature thereof constant throughout said stretch.

12. The apparatus according to claim 10, comprising ducts (21) for bringing to said atomization device a flow of carrier fluid thermally conditioned via means (23) for heat conditioning of the carrier fluid, said ducts (21) being thermally coupled at least with said duct (15) for delivery of thermovector fluid in order to bring into equilibrium the temperature of the body of the atomization device (1) and of the paint-carrier fluid.

13. The apparatus according to claim 12, wherein the paint-carrier fluid is sent into the conduit (19) via the inlet (40), and the outlet of the conduit (41) is connected by means of a duct (42) to the inlet (5) of the carrier fluid in the atomization device (1).

14. The apparatus according to claim 10, wherein said adjustable means for heat conditioning of the thermovector fluid comprise an electrical resistance (27) immersed in a reservoir (18) of thermovector fluid of the unit (14), operatively connected to a thermoregulator (30).

15. The apparatus according to claim 10, wherein said adjustable means (24, 25, 26, 27, 28) for heat conditioning of the thermovector fluid comprise an adjustable cooling device (24) operatively connected to a thermoregulator (30).

16. The apparatus according to claim 10, wherein said thermovector fluid is a non-flammable fluid, preferably one with a base of propylene glycol, water, and inhibitors.

17. The apparatus according to claim 10, wherein said adjustable heat-conditioning means (24, 25, 26, 27, 28) comprise a sensor (25) for detecting the pressure of said carrier fluid, which is capable of enabling heat conditioning of the thermovector fluid in the presence of a predetermined operating thrust pressure and disabling it in the absence of operating pressure.

18. The apparatus according to claim 1, wherein said conductive body (9) is a one piece body.

19. The apparatus according to claim 1, wherein said conductive body (9) is a box shaped body made of welded plates (45, 46, 47, 48).

20. An automatic air-painting plant, comprising:
at least one automatic arm (R) carrying an atomization device (1) for sending a fan of paint (V) onto a substrate (S); and
at least one apparatus according to claim 10 applied to said atomization device (1).
